(19) United States
(12) Patent Application Publication
(10) Pub. No.: US 2014/0196364 A1
(43) Pub. Date: Jul. 17, 2014

(54) APPARATUS AND SYSTEM TO CONVERT PLANTERS INTO INDIVIDUAL GREENHOUSES

(71) Applicant: Jonathan E. Mayner, Issaquah, WA (US)

(72) Inventor: Jonathan E. Mayner, Issaquah, WA (US)

(21) Appl. No.: 13/788,101

(22) Filed: Mar. 7, 2013

Related U.S. Application Data
(60) Provisional application No. 61/753,286, filed on Jan. 16, 2013.

(51) Int. Cl. A01G 13/04

(52) U.S. Cl. CPC A01G 13/04
USPC 47/29.1; 47/20.1; 47/29.5; 47/31

(57) ABSTRACT

A kit is provided that protects vegetation from external elements by turning any pot or planter into a greenhouse so that a person can grow fruit, vegetables, or flowers on a deck, patio, rooftop or yard. The kit provides a frame structure and a transparent cover supported by the frame structure that covers the plant. Plants can be started early in the season to extend the growing period. Plants can be grown even when the weather is still cool.

### CLAIM OF PRIORITY TO FILED APPLICATION

The present application claims priority to U.S. Provisional Application No. 61/753286, filed Jan. 16, 2013, the disclosure of which is hereby incorporated by reference in its entirety.

### FIELD AND BACKGROUND OF THE INVENTION

The invention relates generally to a device that turns pots or planters into individual greenhouses.

Currently there are a number of devices to create small greenhouses. Some of these attempt to make it easier to grow plants indoors, but they fail to meet the needs of the user because they are not flexible and can easily break or are cumbersome to use. Other systems attempt to be portable greenhouses, but they are similarly unable to meet the needs of the user because the plants can easily outgrow them because they do not fit right over a pot or planter.

One prior art example is shown in U.S. Pat. No. 4,265,049 to Gorewitz for placing a transparent cover over a potted plant but it suffers from the design defect of the cover collapsing upon itself and onto the plant (thereby damaging the plant) for lack of structural integrity or a good design. Therefore, there currently exists a need in the industry for a system that can turn any pot or planter into an individual greenhouse that will protect and preserve the plant that is being covered.

### SUMMARY OF THE INVENTION

The various example embodiments described herein advantageously address the aforementioned deficiencies of the prior art and market by providing a means for turning a pot or planter into an individual greenhouse thereby providing a way to grow plants, food and other items indoors in the winter or during inclement weather. The various embodiments provide, but are not limited to, the following advantages: a system that is flexible and can easily fit over an existing pot or planter to create a greenhouse; does not take up any more room than the planter itself; is usable for outside plants and bushes during inclement or cold weather when the system is appropriately configured for same; and a system that is easily collapsible for storage and conserves space; and a system that is a cost-effective solution for growing food and other plants (or pre-growing plants or food before spring) indoors during colder months.

In one example embodiment, the greenhouse system described herein uses a simple plastic cover that is flexible (translucent or transparent such a polyethylene sheet material). The cover support structure is made of a large plastic (or other material) ring member at the top, rounded to create a rounded surface to prevent rain (or snow) from accumulating, and with three or more legs or anchor rods that go directly into the soil (or ground, depending on the application). The legs are movable within the top ring member to accommodate different size pots. In a related embodiment, the upper ring member is configured to be either smaller or larger to accommodate potted plants of varying sizes. In yet another related embodiment, the upper support member is configured in different shapes to accommodate different pot sizes and shapes, hence the shape selected from the group consisting of a ring/circle, square, rectangle, and oval. The upper support member would have different configurations of openings to accept the anchor members or legs.

A system for protecting vegetation from external elements, the system comprising: frame structure means configured to be placed near the vegetation and adapted to be sized as a function of size of the vegetation. The system further includes cover means configured to be disposed over the vegetation and adapted to be supported by the frame structure means, the cover means comprised of at least one open end and a supported end opposite the at least one open end, the supported end adapted to be in operative contact with a portion of the frame structure means, wherein said frame structure means is comprised of a support member coupled to at least one vertical member. The support member includes at least one opening or aperture adapted to receive the at least one vertical member. In a related embodiment, the support member includes a plurality of openings adapted to receive at least two vertical members, wherein the openings and the vertical members are adjustable according to a height and a width of the vegetation. The cover means is comprised of a translucent and pliable material. In a related embodiment, cover means is comprised of a transparent and pliable material.

A kit for protecting vegetation from external elements comprising a frame structure means configured to be placed near the vegetation and adapted to be sized as a function of size of the vegetation. The kit also includes cover means configured to be disposed over the vegetation and adapted to be supported by the frame structure means, the cover means comprised of at least one open end and a supported end opposite the at least one open end, the supported end adapted to be in operative contact with a portion of the frame structure means, wherein the frame structure means is comprised of a support member including an opening adapted to receive at least one vertical member. The support member of the kit further includes a plurality of openings adapted to receive at least two vertical members, wherein the openings and the vertical members are adjustable according to a height and a width of the vegetation. In a related embodiment, the cover means is comprised of a transparent and pliable material, said cover means further including a plurality of apertures.

The various embodiments described herein will now be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIGS. 1A and 1B illustrate an isometric view of a greenhouse growing system and kit, respectively, according to the teachings herein.

FIG. 2 illustrates an isometric view of a greenhouse or vegetation cover according to the teachings herein.

FIG. 3 illustrates a bottom view of the vegetation cover according to the teachings herein.

FIG. 4 illustrates a top view of the vegetation cover according to the teachings herein.

FIG. 5 illustrates a front view of a support structure or a stand according to the teachings herein.

FIG. 6 illustrates a top view of an upper portion of the support structure or stand according to the teachings herein.

FIG. 7 illustrates another example embodiment of a greenhouse system according to the teachings herein.

### DETAILED DESCRIPTION OF THE PREFERRED EMBODIMENTS

Following below are more detailed descriptions of various related concepts related to, and embodiments of, methods and apparatus for an improved greenhouse system for potted or delicate plants. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

In one example embodiment, the greenhouse system described herein uses a simple plastic cover that is flexible (translucent or transparent such a polyethylene sheet material). The cover support structure is made of a large plastic ring member at the top, rounded to create a rounded surface to prevent rain (or snow) from accumulating, and with three or more legs or anchor rods with the top ring being configurable to accommodate at least three legs but not limited to three (3) legs that go directly into the soil (or ground, depending on the application). The legs are movable within the top ring member, by moving the legs inward or outward from opening to opening in the ring member, to accommodate different size pots.

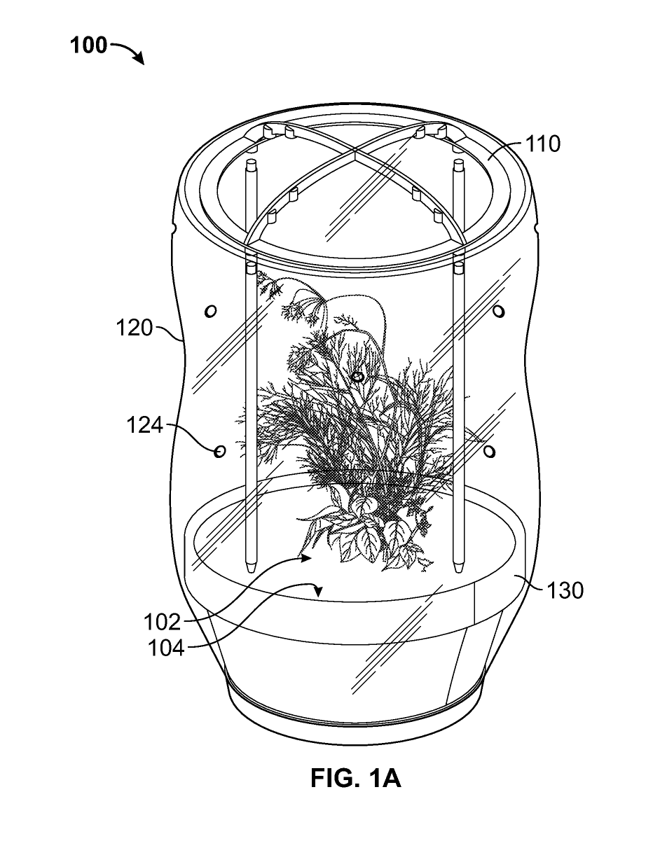

Referring to the figures, FIGS. 1A and 1B illustrate an example embodiment of a small or miniature greenhouse system 100 (and kit 100B) comprised of a support stand or structure assembly 110 and a flexible plastic and transparent cover 120. In this example, cover 120 is configured to fit over the top of stand or support assembly 110 and to be supported thereby over a plant or vegetation 102 and in a pot 130 with dirt or planting mix 104. A greenhouse kit 100B is shown in FIG. 1B that includes a configurable support assembly 110, adapted to expand or contract depending on the vegetation to be covered or enveloped, and a translucent cover 120 having a vent or flap 122 and a plurality of vents or ventilation holes 124 and a closing strap or belt 126. In a related embodiment, flap 122 includes a closure mechanism (such as a zipper, a snap button or hook and loop fastening system similar to a Velcro® system) for watering, with ventilation holes 124. In a related embodiment, cover 120 includes a hook and loop fastening (Velcro®) strap 126 or snaps at the bottom to secure it to stand 110 or pot 130. In a related embodiment, flap 122 includes a slit opening on cover 120 and uses, a hook and loop fastening system, snaps or hook and loop strips to close the slit opening.

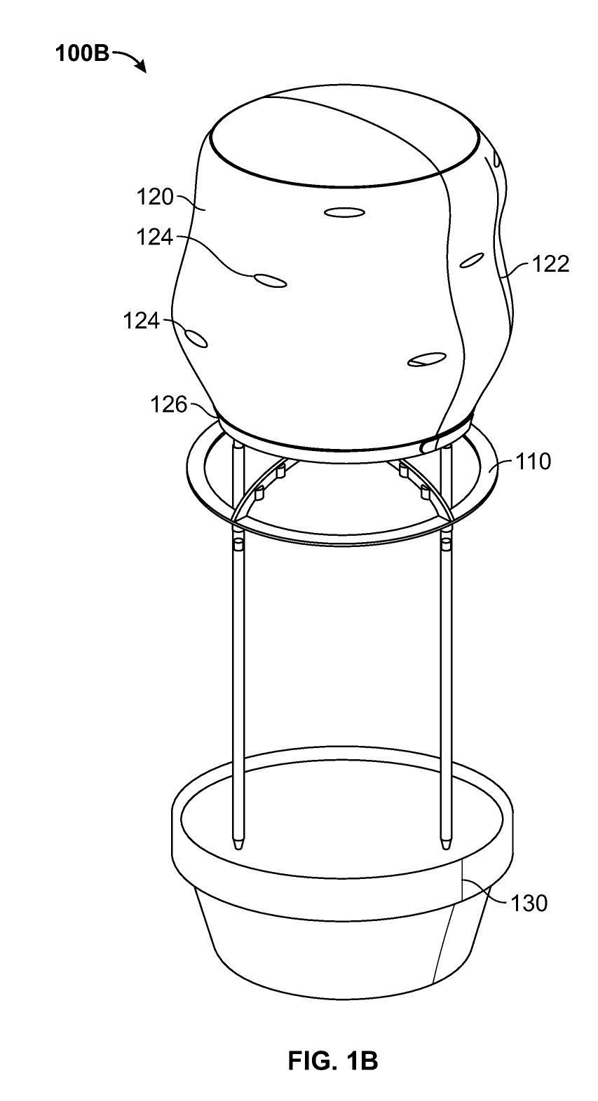

Referring now to FIG. 2, there is illustrated cover 120 with a plurality of vents 124 disposed throughout the cover to allow air to circulate in and out. The number and size of vents are configurable depending on the intended use of cover 120. Cover 120 in this example embodiment is flexible and transparent. In a related embodiment, the cover is translucent (or has an ultraviolet coating, or is made from ultraviolet protected material) to prevent harsh midday rays of the sun from damaging a plant or vegetation.

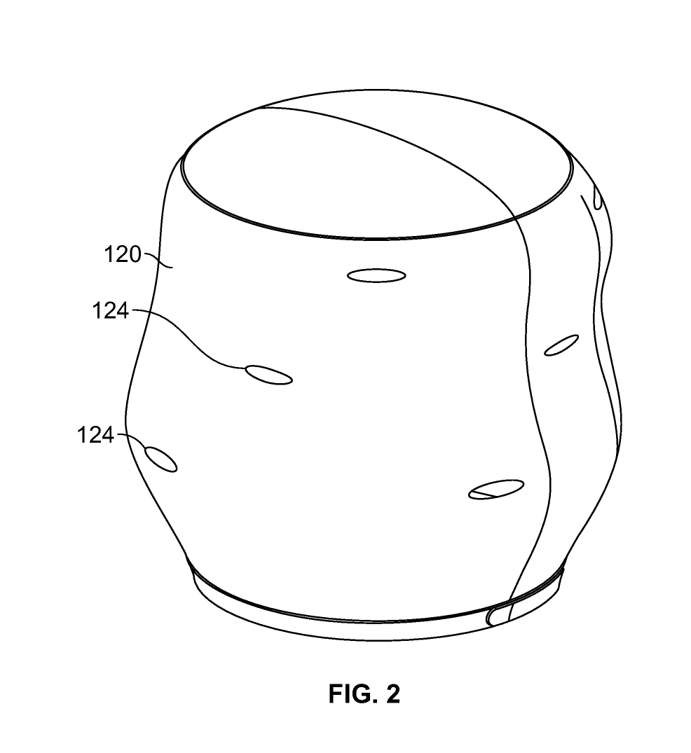

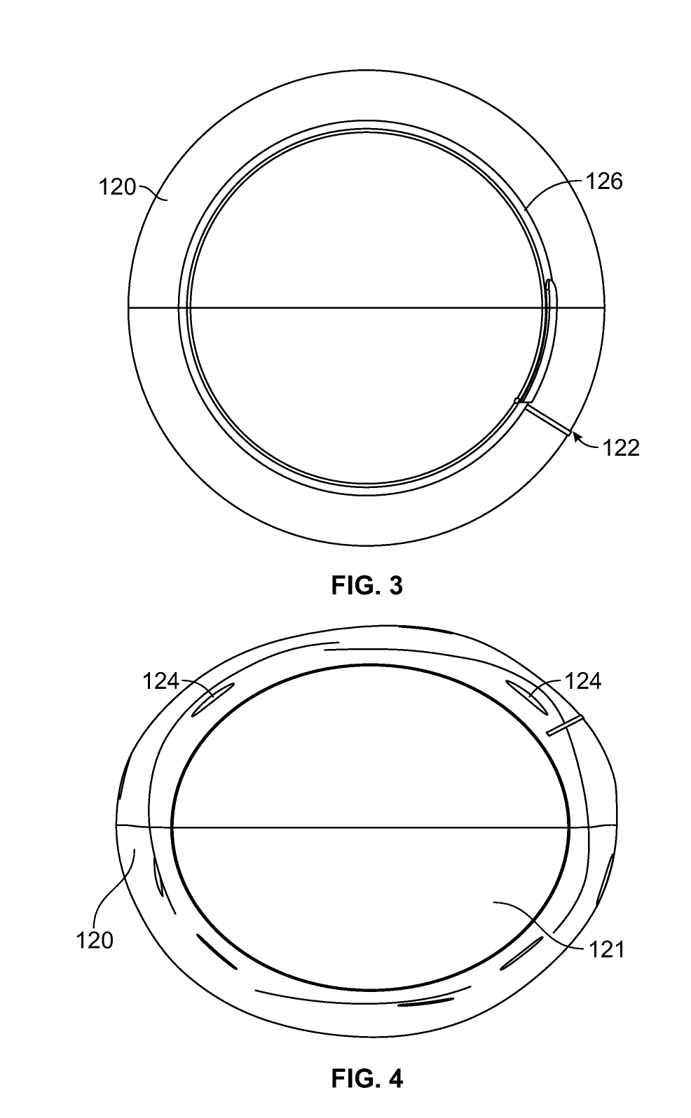

Referring now to FIG. 3, there is illustrated the opening of greenhouse cover 120 on the bottom (near where the pot is located or the ground it sits on if used outside). Referring now to FIG. 4, there is illustrated a top 121 of cover 120 that fits over support stand 110 and has, in this example embodiment, a flap for easy access to the plant. In another embodiment, cover 120 does not include a flap at the upper end. Cover 120 is configurable in various shapes and is not limited to an elongate sleeve-like shape. Cover 120 is configurable in various kits to accommodate round pots, square pots, rectangular potting trays or similar arrangements in the garden or yard if the vegetation is not potted. Depending upon cover 120 and the kit selected for the type of pot to be covered, the kit can include one or more support members that are spaced from each other to support the cover over the vegetation.

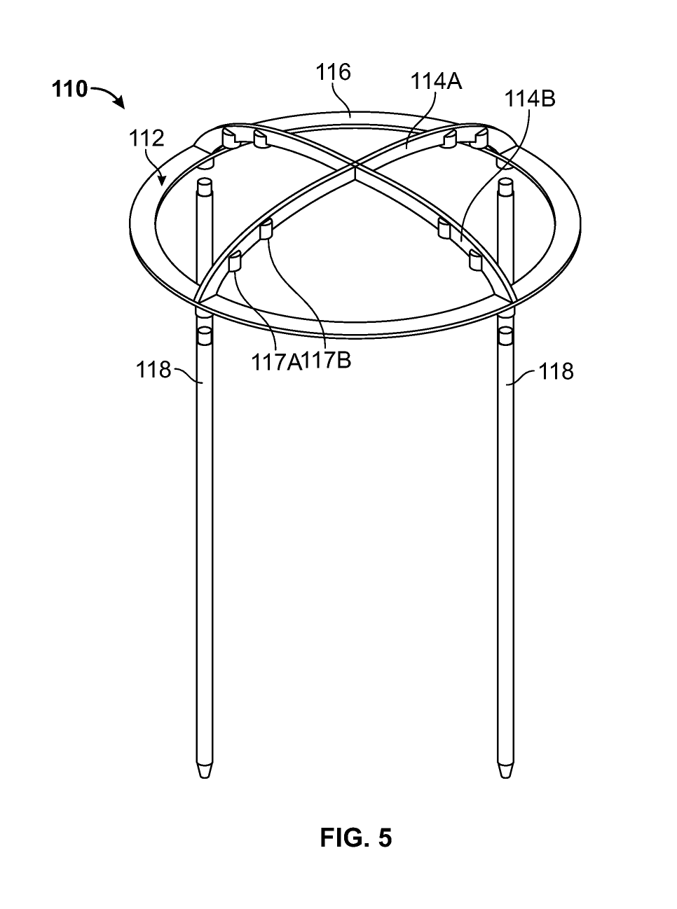

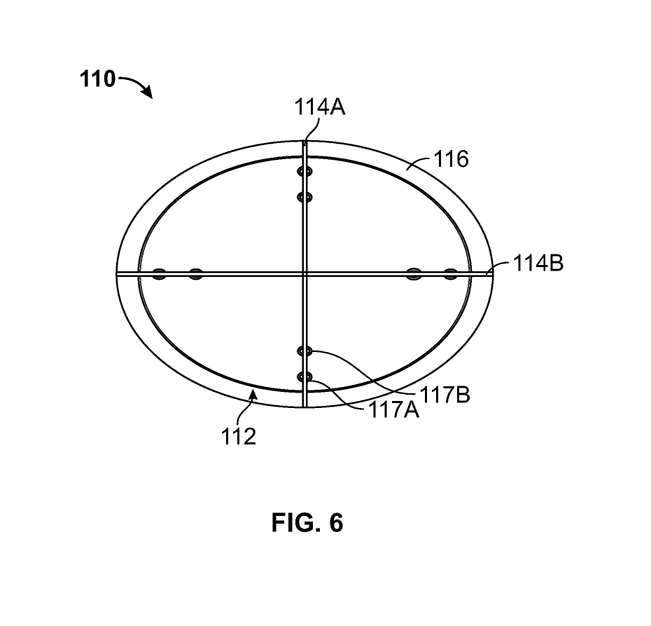

Referring now to FIGS. 5 and 6, there is illustrated a perspective and top views of support stand or assembly 110 that keeps greenhouse cover 120 properly in place and prevents the cover from collapsing onto itself and the plant. In this example embodiment, support assembly 110 is comprised of an upper dome shaped ring member 112 having crossing members 114A and 114B that terminate at outer ring 116. Crossing members 114 include a plurality of coupling sleeves 117A and 117B formed therein and adapted to receive a set of rods 118 that support ring member 112 over a pot and supports cover 120. Sleeves 118 allow for sizing of support assembly 110 into or outside of the pot (or on the ground if used outside) to accommodate plants of different widths and heights. As a rod 118 is moved from 117A to 117B the assembly is narrowed in width. Rod 118 can also be made of several members that are joined together to increase their length (hence their height) or can be made of a telescoping structure to increase or decrease its length. In this example embodiment, support assembly 110 is made from plastic but in other embodiments it is made from steel, aluminum, wood, wire or other rigid materials. In a related embodiment, the rods or legs are movable within the top ring member, by moving the legs inward or outward from opening to opening (or coupling sleeve to coupling sleeve) in the ring member, to accommodate different size pots.

In a related embodiment, support assembly (frame structure means) or member 110 that supports cover 120 is made in the form of a grid or panels made from a semi-rigid lattice material (such as wire mesh or plastic mesh) or wood thereby eliminating the upper support member and/or the supporting legs that can be placed in the perimeter of the pot or soil on the ground outside. This example embodiment provides for a simplified greenhouse kit having a cover 120 and a roll of semi-rigid (or rigid) lattice wire that is extended out about a perimeter of the vegetation to support cover 120 over the vegetation. In yet another related embodiment, support assembly 110 is made of lattice plates that are spaced from each other to form a support structure for cover 120 over the vegetation. In another related example embodiment, said frame structure means includes lattice or solid plates configured with soil anchor members, wherein the plates are adapted to support cover means over the vegetation.

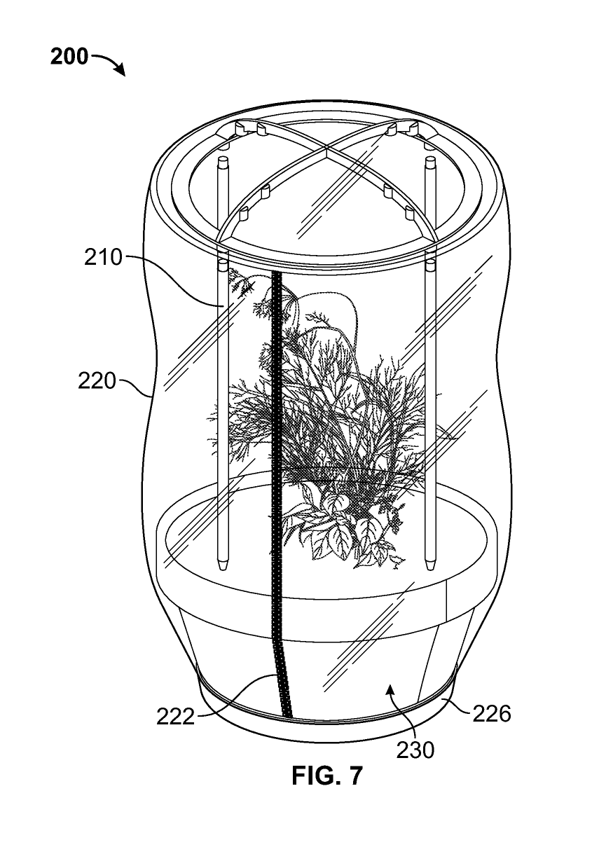

Referring now to FIG. 7, this example embodiment illustrates a greenhouse system 200 according to the teachings herein. In this example embodiment, structure assembly 210 is covered with a flexible plastic cover 220 that includes a zipper 222 for watering. In a related embodiment, cover 220 includes a plurality of ventilation holes and in yet another embodiment the holes includes individual flaps that can be opened and closed as desired. Cover 220 includes a strap 226 with a fastener, such as a hook and loop (Velcro®) fastener, or snaps at the bottom to secure it to support assembly 210 or to pot 230. In a related embodiment, zipper 222 is replaced with a slit opening on cover 220 which used snaps or hook and loop strips to close the slit opening.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A system for protecting vegetation from external elements, the system comprising:
frame structure means configured to be placed near the vegetation and adapted to be sized as a function of size of the vegetation; and
cover means configured to be disposed over the vegetation and adapted to be supported by said frame structure means, said cover means comprised of at least one open end and a supported end opposite the at least one open end, the supported end adapted to be in operative contact with a portion of said frame structure means.

2. The system of claim 1 wherein said frame structure means is comprised of a support member coupled to at least one vertical member.

3. The system of claim 2 wherein the support member includes at least one opening or aperture adapted to receive the at least one vertical member.

4. The system of claim 3 wherein the support member includes a plurality of openings adapted to receive at least two vertical members, wherein the openings and the vertical members are adjustable according to a height and a width of the vegetation.

5. The system of claim 1 wherein said cover means is comprised of a translucent and pliable material.

6. The system of claim 1 wherein said cover means is comprised of a transparent and pliable material.

7. The system of claim 6 wherein said cover means includes a plurality of apertures.

8. The system of claim 7 wherein at least one aperture includes a retractable cover or flap.

9. The system of claim 6 wherein said cover means includes at least one retractable flap at a location selected from the group consisting of at or near the open end, over a vent on said cover means, under a vent on said cover means and a side of a vent on said cover means.

10. The system of claim 6 wherein said cover mean includes a closing mechanism selected from the group consisting of a zipper, a hook and loop fastening system, one or more snap buttons, along a surface of said cover means.

11. The system of claim 1 wherein said the supported end of said cover means is configured as a retractable flap.

12. The system of claim 1, wherein said frame structure means includes a flexible semi-rigid lattice member adapted to support said cover means over the vegetation.

13. The system of claim 12, wherein the flexible lattice member is configured from material selected from the group consisting of a wire mesh, a plastic mesh and a wood-wire mesh combination.

14. The system of claim 1 wherein said frame structure means includes lattice or solid plates configured with soil anchor members, wherein the plates are adapted to support cover means over the vegetation.

15. A kit for protecting vegetation from external elements comprising:
frame structure means configured to be placed near the vegetation and adapted to be sized as a function of size of the vegetation; and
cover means configured to be disposed over the vegetation and adapted to be supported by said frame structure means, said cover means comprised of at least one open end and a supported end opposite the at least one open end, the supported end adapted to be in operative contact with a portion of said frame structure means, wherein said frame structure means is comprised of a support member including an opening adapted to receive at least one vertical member.

16. The kit of claim 15 wherein the support member includes a plurality of openings adapted to receive at least two vertical members, wherein the openings and the vertical members are adjustable according to a height and a width of the vegetation.

17. The kit of claim 15 wherein said cover means is comprised of a transparent and pliable material, said cover means further including a plurality of apertures.

18. The kit of claim 17 wherein at least one aperture includes a retractable cover or flap.

19. The kit of claim 15 wherein said cover means includes at least one retractable flap at a location selected from the group consisting of at or near the open end, over a vent on said cover means, under a vent on said cover means and a side of a vent on said cover means.

20. The kit of claim 15 wherein said cover mean includes a closing mechanism selected from the group consisting of a zipper, a hook and loop fastening system, one or more snap buttons, along a surface of said cover means.
